(19) United States
(12) Patent Application Publication
(10) Pub. No.: US 2024/0114562 A1
(43) Pub. Date: Apr. 4, 2024

(54) INITIATING COMMUNICATION IN A PERSONAL AREA NETWORK

(71) Applicant: ABL IP Holding, LLC, Conyers, GA (US)

(72) Inventors: Robert W. HAMLIN, Monroe, CT (US); Philip S. GROSS, Berlin, CT (US); Che Chung KO, Johns Creek, GA (US)

(21) Appl. No.: 17/936,898

(22) Filed: Sep. 30, 2022

(51) Int. Cl. H04W 76/10; H04W 48/10; H04W 52/02

(52) U.S. Cl. CPC H04W 76/10; H04W 48/10; H04W 52/0229

(57) ABSTRACT

In an approach to generating a wake-up advertisement to a remote device, a system includes: a computing device comprising communications circuitry, including an advertisement initiation circuitry; one or more computer processors; one or more non-transitory computer readable storage media; and instructions stored on the one or more non-transitory computer readable storage media for execution by at least one of the one or more computer processors. The instructions include: send one or more wake-up advertisements to one or more remote devices; receive one or more connection advertisements from the responding remote device; and responsive to receiving the one or more connection advertisements from the responding remote device, connect to the responding remote device.

### TECHNICAL FIELD

The present disclosure relates to initiating communication in a Personal Area Network (PAN).

### BACKGROUND

Pairing is a process used in computer networking that establishes an initial linkage between computing devices to allow communications between them. The most common example of pairing is used in Bluetooth®, where the pairing process is used to link devices like a Bluetooth headset with a mobile phone. In the pairing process, some physical action is taken on the remote device to put it into advertising mode. This is usually done by a pushbutton press or similar activity. This type of pairing process is extremely common in the wireless communications world. There are situations where no methods are available to put the remote device into advertising mode, and having the remote device constantly send advertisements is undesirable due to security and power consumption concerns, and to prevent excessive use of the airwaves.

### BRIEF DESCRIPTION OF THE DRAWINGS

Features and advantages of various embodiments of the claimed subject matter will become apparent as the following Detailed Description proceeds, and upon reference to the Drawings, wherein like numerals designate like parts, and in which:

FIG. 1 illustrates an example system for initiating communication in a personal area network, in accordance with an embodiment of the present disclosure;

FIG. 2 is a sequence diagram depicting operations for the wake-up and connect procedure, in accordance with an embodiment of the present disclosure;

FIG. 3A illustrates an illustrative example of a packet structure for an advertising packet, in accordance with an embodiment of the present disclosure;

FIG. 3B is an example table of Advertising Data (AD) types, in accordance with an embodiment of the present disclosure;

FIG. 3C is an example table of AD types for a wake-up advertisement, in accordance with an embodiment of the present disclosure;

FIG. 3D is an example table of AD types for a service advertisement, in accordance with an embodiment of the present disclosure;

FIG. 4A illustrates an illustrative example of a packet structure for a scan request packet, in accordance with an embodiment of the present disclosure.

FIG. 4B is an example table of a single data field in a wake-up scan response, in accordance with an embodiment of the present disclosure; and

FIG. 4C is an example table of the scan response for the PAN service, in accordance with an embodiment of the present disclosure.

Although the following Detailed Description will proceed with reference being made to illustrative embodiments, many alternatives, modifications, and variations thereof will be apparent to those skilled in the art.

### DETAILED DESCRIPTION

The present disclosure provides systems and methods to solve the problem of how to put remote devices into advertising mode. In example embodiments, the remote device is configured to scan for advertisements, and the computing device is configured to send advertisements that cause the remote device to ‘wake up’ and begin advertising in a standard fashion.

There are many cases where a computing device, such as a computer, laptop, or a smartphone, needs to communicate with a remote device, such as a headset or wireless speakers. To ensure that this communication remains secure against unwanted users, and when the two endpoints intend to communicate over a PAN, for example, Bluetooth or Bluetooth Low Energy (BLE), typically a pairing process is first executed.

In the pairing process, some action is taken on the remote device to put it into advertising mode. The remote device may be put into advertising mode by a pushbutton press or other activity that involves physical interaction between the user of the computing device and the actual remote device. In advertising mode, the remote device sends PAN advertisements at regular intervals, which are communications packets containing information about the device and its intent to connect.

At the same time the remote device is advertising, the computing device is told to begin scanning for advertisements. Scanning may be initiated by the user through a feature on the computing device using, for example, a graphical user interface. When scanning, the computing device keeps its Radio Frequency (RF) receiver circuitry turned on and examines incoming packets to check for advertisements. This is in contrast with a paired communications session in which the computing device alternates sending its own packets with listening for incoming packets and is only interested in packets from the device with which it is paired.

This type of pairing process is extremely common in wireless communications and is typically structured the same way, i.e., the remote device advertises, and the computing device scans. There are situations where no methods are available to put the remote device into advertising mode, and having the remote device constantly send advertisements is undesirable due to security and power consumption concerns, and to prevent excessive use of the airwaves.

An example of one such situation is a streetlight. Today's streetlights offer features and flexibility that are complex enough to support a large number of internal settings, which are typically controlled electronically. To avoid climbing the pole and shutting off power to the fixture, it is desirable to communicate with the fixture over a wireless protocol like a PAN, but typical methods used to initiate the pairing process are not available. Pushbuttons are not a consideration because they can be tampered with by people on the street. Cycling the power to the fixture is another alternative but this can be extremely inconvenient in many installations and when dealing with public utilities. For example, it may not be possible to turn off the power to a single streetlight to initiate pairing without turning off a series of connected streetlights, which may not be desirable. Aiming a flashlight at the fixture can work but is unreliable in bright sunlight.

There exists a need to put remote devices into advertising mode to initiate communication in a personal area network. The system disclosed herein solves the problem of how to put remote devices into advertising mode by having the remote devices constantly scanning for advertisements and using a computing device, e.g., a smartphone or other mobile device, to send advertisements that cause the remote device to wake up and begin advertising in the standard fashion. Thus, this disclosure is a novel and effective solution to a difficult problem.

Disclosed herein is a system to initiate a wireless pairing process between a computing device, e.g., a smartphone, and a remote device. Typically, the remote device does not have available any of the methods used to initiate pairing such as a pushbutton or power cycling. A streetlight is a representative example of such a device.

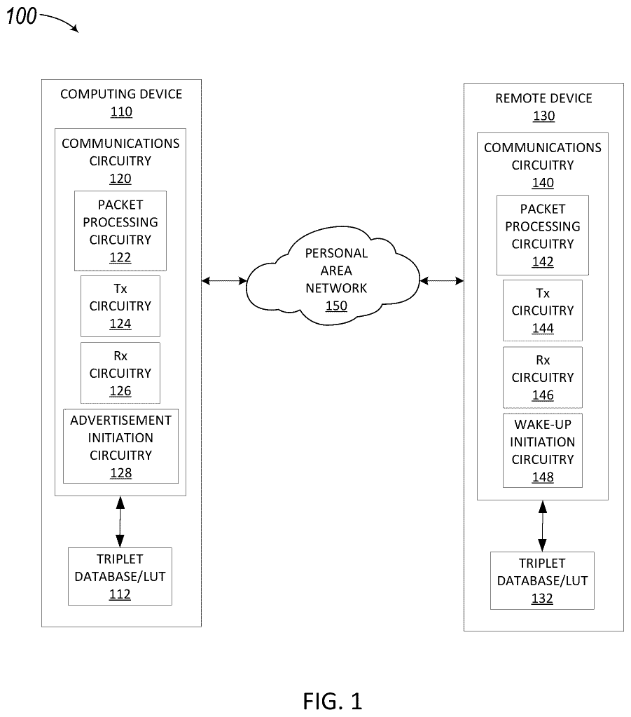

FIG. 1 illustrates an example system, generally designated 100, for initiating communication in a personal area network, in accordance with an embodiment of the present disclosure. FIG. 1 provides only an illustration of one implementation and does not imply any limitations with regard to the environments in which different embodiments may be implemented. Many modifications to the depicted environment may be made by those skilled in the art without departing from the scope of the disclosure as recited by the claims.

System 100 includes computing device 110 optionally connected to a PAN 150. The PAN 150 can be, for example, a Bluetooth or BLE network. In general, the PAN 150 can be any combination of connections and protocols that will support communications between computing device 110 and remote device 130 within system 100. Although many of the descriptions that follow include references to processes and structures that would be appropriate for a PAN based on Bluetooth or BLE, it would be apparent to a person of skill in the art that they are appropriate for any currently known, after-developed, commercially available, and/or proprietary PAN protocols, such as Bluetooth, BLE, Zigbee, Ultrawideband, etc.

Computing device 110 can be a mobile computing device, a standalone computing device, or any other electronic device or computing system capable of receiving, sending, and processing data, while connected with a remote device over the PAN 150. In an embodiment, computing device 110 can be a smart phone, a laptop computer, a tablet computer, a netbook computer, or any programmable electronic device capable of communicating with other computing devices (not shown) within system 100 via PAN 150.

Computing device 110 includes communications circuitry 120 to communicate over the PAN 150. Communications circuitry 120 includes packet processing circuitry 122, which contains algorithms to control and guide a packet through the PAN 150, as well as algorithms to secure the packets as they traverse the PAN 150. Communications circuitry 120 also includes Tx circuitry 124 and Rx circuitry 126, which provide transmission and reception services, respectively, over the PAN 150. In some embodiments, Tx circuitry 124 and Rx circuitry 126 provide transmission and reception services using RF communications.

Communications circuitry 120 also includes advertisement initiation circuitry 128, which is the circuitry that allows for the computing device 110 to initiate communication in a personal area network, e.g., the PAN 150. Advertisement initiation circuitry 128 allows computing device 110 to wake up a remote device, such as remote device 130.

Computing device 110 also includes triplet database/LUT (Look-Up Table) 112. In an embodiment, triplet database/LUT 112 contains a series of structures for the data to advertise over the PAN 150 in order to wake up and connect to a remote device, such as the remote device 130.

System 100 includes remote device 130 optionally connected to the PAN 150. As described above, remote device 130 does not have available any of the typical methods used to initiate pairing such as a pushbutton or power cycling. Instead, remote device 130 uses the disclosed system to initiate communication in a personal area network, e.g., the PAN 150, without requiring user intervention to initiate the wake-up process. Similar to computing device 110, remote device 130 includes communications circuitry 140 to communicate over the PAN 150. Communications circuitry 140 includes packet processing circuitry 142, which contains algorithms to control and guide a packet through the PAN 150, as well as algorithms to secure the packets as they traverse the PAN 150. Communications circuitry 140 also includes Tx circuitry 144 and Rx circuitry 146, which provide transmission and reception services, respectively, over the PAN 150. In some embodiments, Tx circuitry 144 and Rx circuitry 146 provide transmission and reception services using Radio Frequency (RF) communications.

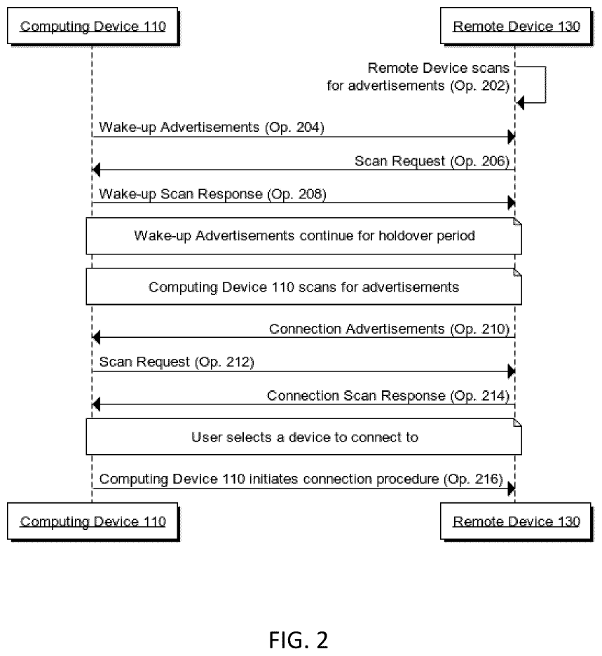

Communications circuitry 140 also includes wake-up initiation circuitry 148, which is the circuitry that allows for the computing device 110 to initiate communication in a personal area network, e.g., the PAN 150 without requiring user intervention to initiate the wake-up process on remote device 130. Wake-up initiation circuitry 148 allows computing device 110 to wake up the remote device 130 as described below in FIG. 2.

Remote device 130 also includes triplet database/LUT (Look-Up Table) 132. In an embodiment, triplet database/LUT 112 contains a series of structures for the data used to advertise over the PAN 150 in order to allow a device to wake up and connect to the remote device 130.

FIG. 2 is a sequence diagram depicting operations for the wake-up and connect procedure, in accordance with an embodiment of the present disclosure. It should be appreciated that embodiments of the present disclosure provide at least for initiating communication in a personal area network. However, FIG. 2 provides only an illustration of one implementation and does not imply any limitations with regard to the environments in which different embodiments may be implemented. Many modifications to the depicted environment may be made by those skilled in the art without departing from the scope of the disclosure as recited by the claims.

The remote device 130 scans for advertisements (operation 202). In the illustrated example embodiment, the remote device 130 scans for advertisements by setting its radio frequency (RF) receiver circuitry, such as Rx circuitry 146 from FIG. 1, into listening mode. The remote device then remains in this mode until it receives an appropriate advertisement. In an embodiment, the remote device is configured to always be scanning for advertisements when it is not paired. In an embodiment, this may happen automatically after power up, or following a reset or enable procedure.

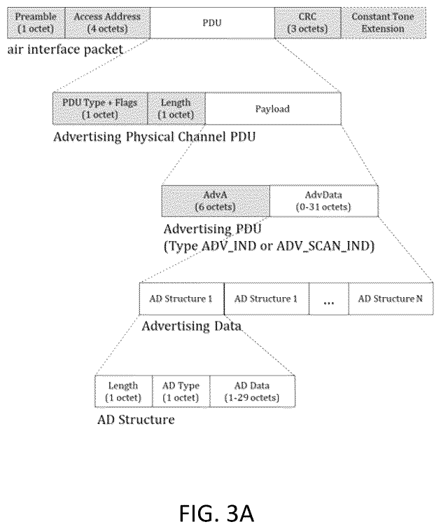

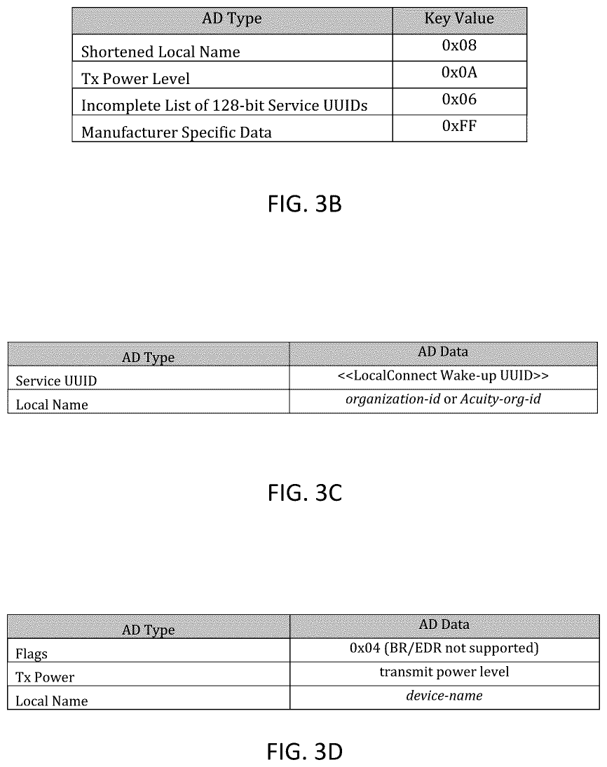

The computing device 110 sends wake-up advertisements (operation 204). In operation 204, the computing device 110 sends wake-up advertisements via its RF transmitter circuitry, e.g., Tx circuitry 124 from FIG. 1, to potential remote devices using specialized advertisement packets. One example of a packet structure that may be used for the wake-up advertisements is illustrated in FIG. 3A. The packet structure illustrated in FIG. 3A is an example of a packet structure that may be used by a PAN such as BLE. In the example of a BLE packet, the bytes highlighted in gray are defined by the BLE specification. In the example packet structure of FIG. 3A, AdvA is the address of the advertiser, i.e., the Bluetooth address of the computing device 110. The Advertising Data (AD) is the contents of an advertisement, i.e., a series of AD Structures where each AD Structure is typically a (length, type, data) triplet.

The AD Type is a key that indicates what is contained in the AD Data field while the Length field is the number of bytes in the AD Type plus Data fields. Some examples of AD Types are shown in FIG. 3B. FIG. 3C is an example table of AD types for a wake-up advertisement, and FIG. 3D is an example table of AD types for a service advertisement.

While FIG. 3A illustrates one possible example of the packet structure for wake-up advertisements, this disclosure is not limited to the example packet structure of FIG. 3A, and many other potential packet structures may be used.

In an embodiment, the wake-up advertisement structure may include the following fields: Type ADV_SCAN_IND (scannable, undirected); AdvA address of the advertiser (mobile device, typically); AdvData—(25 bytes plus 3-byte Flags field); Service UUID (18 bytes); Length: 0x11 (1 byte); AD Type: Incomplete List of 128-bit Service UUIDs—0x06 (1 byte); Contents: (16 bytes); <<Wake-up UUID>>; Local Name (7 bytes); Length: 0x07 (1 byte); AD Type: Complete Local Name—0x09 (1 byte); Contents: (6 bytes); and String (organization-id) (6 bytes). The organization-id is the one corresponding to the organization that the user has navigated to after login.

In an embodiment, the Flags field is required in this advertisement but not shown above because it will be automatically inserted by the mobile device operating system. The computing device must be able to handle the presence or absence of the Flags field when receiving this advertisement. For information, the Flags field should look like this: Flags (3 bytes); Length:0x02 (1 byte); AD Type: Flags—0x01 (1 byte); Contents: 0x04 (1 byte); BR/EDR not supported (bit 2).

In an embodiment, the computing device 110 may be configured to automatically connect to any devices that are in range, or it can connect to devices that are selected by a user. When the user starts the computing device 110 and indicates it should begin looking for remote devices, the computing device 110 begins sending PAN advertisements. If no devices are found, the advertisement may continue indefinitely, until the user stops the process, or after a predetermined timeout period.

The advertisements may include information about the system and the sender, so that only certain remote devices will respond. For example, the advertisement may include an indication that it is used in a system that controls streetlights. This way, if the remote device detects unrelated advertisements coming from other devices, it knows it need not respond and should continue scanning for useful advertisements. For another example, in a multi-tenant system, there may be many devices in the field that belong to one of several organizations. If the advertisements include an identifier related to one organization, only those devices belonging to that organization will respond.

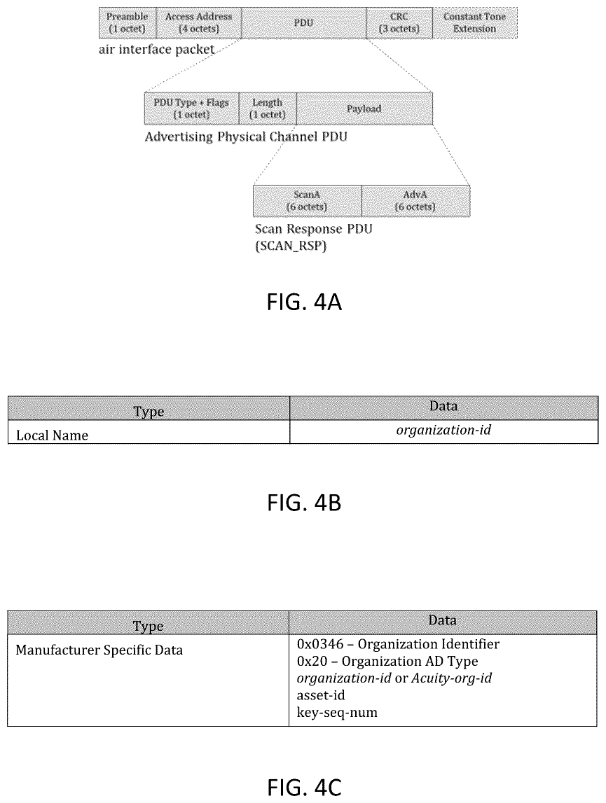

The remote device 130 sends a wake-up scan request (operation 206). In some embodiments, when the remote device 130, which is scanning for wake-up advertisements, receives the proper type of wake-up advertisement, in operation 206 the responding remote device 130 may send a scan request, which is a request for additional information, via its RF transmitter circuitry, e.g., Tx circuitry 144 from FIG. 1, to the computing device 110. In an embodiment, the remote device 130 responds using a specialized scan request packet. One example of a packet structure that may be used for the scan request is illustrated in FIG. 4A. While FIG. 4A illustrates one possible example of the packet structure for the scan request, this disclosure is not limited to the example packet structure of FIG. 4A, and many other potential packet structures may be used.

In an embodiment, the Scan Request may include the following fields: Type: SCAN_REQ; ScanA: address of the scanner (the source address); and AdvA: address to which this request is being sent, i.e., the advertiser (the destination address). In an embodiment, the scan request is defined as specified by the PAN and contains no host data.

The computing device 110 sends a wake-up scan response (operation 208). In some embodiments, upon receiving the scan request, in operation 208, information useful to the remote device that did not fit in the original advertisement may be sent by the computing device 110 in a scan response. In an embodiment, the scan response uses a format similar to the advertisement packet. In an embodiment, the wake-up scan response includes a single data field that specifies the identity of the organization that was sent in the wake-up advertisement. In an embodiment, the scan response is only sent because some software stacks always send a scan request and a scan response.

FIG. 4B is an example table of a single data field in a wake-up scan response. In an embodiment, this is a single data field for a local name, i.e., the organization identification. This is typically the same information that was sent in the wake-up advertisement in operation 204.

FIG. 4C is an example table of the scan response for the PAN service. In an embodiment, the scan response is the final packet sent during the wake-up exchange. The scan response includes the organization identifier. In the case of Bluetooth, for example, the organization identifier is assigned by the Bluetooth Special Interest Group (Bluetooth SIG). In an embodiment, the scan response contains other information for the mobile app to run the PAN service.

In an embodiment, the wake-up scan response structure may include the following fields: Type: SCAN_RSP; AdvA: address of the advertiser (i.e., typically the computing device); ScanRspData: (7 bytes); and Local Name (7 bytes); Length: 0x07 (1 byte); AD Type: Complete Local Name—0x09 (1 byte); Contents: (6 bytes); and String (organization-id). In an embodiment, the wake-up scan response is sent by the advertiser (i.e., the computing device).

In an embodiment, remote device 130 examines the advertisement and the scan response to verify they match a predetermined set of criteria. The criteria may include, but are not limited to, that the advertisement is part of the correct system, that the advertisement is sent as part of the correct PAN service, or that the wake-up advertisement corresponds to the same organization as the remote device 130. The criteria may also be used to target a single remote device, for example, a streetlight.

The receipt of the advertisement and scan response that satisfy the criteria is an indication to the remote device 130 that it should stop scanning for advertisements and begin sending its own advertisements as in the more standard approach. The computing device 110 continues to send its advertisements for an additional holdover period in an effort to wake up one or more additional responding remote devices in the area. The holdover period may be short, e.g., 0.1 seconds, or may extend indefinitely. However, the longer the holdover period is extended, the less likely that additional devices will be found.

After the advertising holdover period ends, the computing device 110 stops sending its wake-up advertisements and starts scanning for incoming advertisements. Note that the computing device 110 may also begin scanning during the holdover period by interleaving advertisements with intervals of scanning and may continue sending advertisements even after it starts scanning or forms a connection.

The computing device 110 receives connection advertisements (operation 210). In some embodiments, while scanning for advertisements, the computing device 110 may begin displaying detected devices to the user. The list of devices may be filtered based on information contained in the received advertisements and the scan responses. For example, the information might include which PAN service is being advertised and to which organization the remote device belongs. In an embodiment, the computing device 110 may only display devices that are of interest to the user and can be connected to by the computing device 110. Using the displayed list of devices, the user can select a device to pair with by indicating a particular device of the one or more remote devices that sent scan requests. The computing device 110 may also be configured to automatically pair with any remote devices, e.g., remote device 130, that it is allowed to pair with to enable autonomous data exchanges.

In an embodiment, the service advertisement structure may include the following fields: Type: ADV_IND (connectable, scannable, undirected); AdvA: address of the advertiser (luminaire Controller); AdvData: (up to 30 bytes); Flags (3 bytes); Length:0x02 (1 byte); AD Type: Flags—0x01 (1 byte); Contents: 0x04 (1 byte); BR/EDR not supported (bit 2); TxPower: (3 bytes); Length: 0x02 (1 byte); AD Type: Tx Power Level—0x0A (1 byte); Contents: (1 byte); TxPower level (see definition above in Section 4.1.2); Local Name (up to 24 bytes); Length: up to 0d23 (1 byte); AD Type: Complete Local Name—0x09 (1 byte); Contents: (up to 22 bytes); and device-name. Note that no manufacturing-specific data is included because most mobile app stacks return advertising data and scan response data all at once.

The computing device 110 sends a connection scan request (operation 212). When the computing device 110 receives an advertisement, it may send a scan request in the same fashion as described above.

The computing device 110 receives a connection scan response (operation 214). After the computing device send a connection scan request in operation 212, the remote device 130 then responds with a scan response containing additional information. The scan request/response exchange is optional, although it happens automatically as part of the many mobile device operating systems.

In an embodiment, the service scan response structure may include the following fields: Type: SCAN_RSP; AdvA: address of the advertiser (luminaire Controller); AdvData: (18 bytes); Manufacturer Specific Data (18 bytes); Length: 0d18 (1 byte); AD Type: Manufacturer Specific Data—0xFF (1 byte); Contents: (17 bytes); Company Identifier (2 bytes); AD Type (1 byte); 0x20 (service scan response); organization-id (6 bytes); asset-id (6 bytes); and key-seq-num (2 bytes).

The computing device 110 initiates a connection procedure (operation 216). In an embodiment, the computing device 110 initiates a connection procedure in accordance with the standard connection procedure for the PAN. For example, if the PAN is BLE, then a standard BLE connection procedure is initiated.

While FIG. 2 illustrate various operations according to one or more embodiments, it is to be understood that not all of the operations depicted in FIG. 2 are necessary for other embodiments. Indeed, it is fully contemplated herein that in other embodiments of the present disclosure, the operations depicted in FIG. 2, and/or other flowcharts and/or operations described herein, may be combined in a manner not specifically shown in any of the drawings, but still fully consistent with the present disclosure. Thus, claims directed to features and/or operations that are not exactly shown in one drawing are deemed within the scope and content of the present disclosure.

As used in this application and in the claims, a list of items joined by the term “and/or” can mean any combination of the listed items. For example, the phrase “A, B and/or C” can mean A; B; C; A and B; A and C; B and C; or A, B and C. As used in this application and in the claims, a list of items joined by the term “at least one of” can mean any combination of the listed terms. For example, the phrases “at least one of A, B or C” can mean A; B; C; A and B; A and C; B and C; or A, B and C.

“Circuitry,” as used in any embodiment herein, may comprise, for example, singly or in any combination, hardwired circuitry, programmable circuitry such as processors comprising one or more individual instruction processing cores, state machine circuitry, and/or firmware that stores instructions executed by programmable circuitry. The circuitry may, collectively or individually, be embodied as circuitry that forms part of a larger system, for example, an integrated circuit (IC), system on-chip (SoC), application-specific integrated circuit (ASIC), programmable logic devices (PLD), digital signal processors (DSP), field programmable gate array (FPGA), logic gates, registers, semiconductor device, chips, microchips, chip sets, etc. The circuitry described herein may be formed of electrical and mechanical components to operate in a manner herein described, as would be understood by one skilled in the art using conventional and/or custom components. For example, in the case of controllable valve circuitry 108 and/or 132, fluid valve components may be formed of mechanical structures (e.g., dampers, baffles, screw valve opening/closing mechanisms, and/or other known types of mechanical valve structures, etc.) and such mechanical structures may be controlled (e.g., moved, urged, rotated, etc.) using controllable electrical components such as valve actuators and the like.

Any of the operations described herein may be implemented in a system that includes one or more non-transitory computer readable storage media having stored therein, individually or in combination, instructions that when executed by circuitry perform the operations. The storage device includes any type of tangible medium, for example, any type of disk including hard disks, floppy disks, optical disks, Compact Disk Read-Only Memories (CD-ROMs), Compact Disk Rewritables (CD-RWs), and magneto-optical disks, semiconductor devices such as Read-Only Memories (ROMs), Random Access Memories (RAMs) such as dynamic and static RAMs, Erasable Programmable Read-Only Memories (EPROMs), Electrically Erasable Programmable Read-Only Memories (EEPROMs), flash memories, Solid State Disks (SSDs), embedded Multimedia Cards (eMMCs), Secure Digital Input/Output (SDIO) cards, magnetic or optical cards, or any type of media suitable for storing electronic instructions. Other embodiments may be implemented as software executed by a programmable control device. Also, it is intended that operations described herein may be distributed across a plurality of physical devices, such as processing structures at more than one different physical location.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents. Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications.

Reference throughout this specification to “one embodiment” or “an embodiment” means that a particular feature, structure, or characteristic described in connection with the embodiment is included in at least one embodiment. Thus, appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

What is claimed is:

1. A system for generating a wake-up advertisement to a remote device, the system comprising:
a computing device comprising:
communications circuitry, including an advertisement initiation circuitry;
one or more computer processors;
one or more non-transitory computer readable storage media; and
instructions stored on the one or more non-transitory computer readable storage media for execution by at least one of the one or more computer processors, the stored instructions including instructions to:
send one or more wake-up advertisements to one or more remote devices;
receive one or more connection advertisements from the responding remote device; and
responsive to receiving the one or more connection advertisements from the responding remote device, connect to the responding remote device.

2. The system of claim 1, wherein send one or more wake-up advertisements to one or more remote devices comprises one or more of the following program instructions, stored on the one or more computer readable storage media, to:
send one or more wake-up advertisements to one or more remote devices;
receive a scan request from a responding remote device;
send a wake-up scan response to the responding remote device; and
scan for one or more connection advertisements from the responding remote device.

3. The system of claim 2, wherein scan for the one or more connection advertisements from the responding remote device further comprises one or more of the following program instructions, stored on the one or more computer readable storage media, to:
send the one or more wake-up advertisements for a holdover period; and
scan for the one or more connection advertisements from one or more additional responding remote devices.

4. The system of claim 3, wherein the computing device scans for the one or more connection advertisements during the holdover period by interleaving the one or more wake-up advertisements with intervals of scanning.

5. The system of claim 1, wherein connect to the responding remote device uses a standard connection procedure for the PAN.

6. The system of claim 5, wherein the PAN is Bluetooth Low Energy (BLE) and connect to the responding remote device uses a standard BLE connection procedure.

7. The system of claim 1, wherein the one or more wake-up advertisements include information about the system and a sender.

8. The system of claim 1, wherein responsive to receiving the one or more connection advertisements from the responding remote device, connect to the responding remote device further comprises one or more of the following program instructions, stored on the one or more computer readable storage media, to:
receive an indication from a user indicating a particular device of the one or more remote devices; and
connect to the particular device of the one or more remote devices.

9. The system of claim 1, wherein the one or more wake-up advertisements use a specialized advertisement packet.

10. A system to receive a wake-up advertisement from a computing device, the system comprising:
a remote device comprising:
communications circuitry, including a wake-up initiation circuitry;
one or more computer processors;
one or more non-transitory computer readable storage media; and
instructions stored on the one or more non-transitory computer readable storage media for execution by at least one of the one or more computer processors, the stored instructions including instructions to:
scan for a wake-up advertisement from a computing device;
receive the wake-up advertisement from the computing device; and
connect to the computing device.

11. The system of claim 10, further comprises one or more of the following program instructions, stored on the one or more computer readable storage media, to:
responsive to receiving the wake-up advertisement from the computing device, send a first scan request to the computing device;
determine whether the wake-up advertisement and a scan response match a predetermined set of criteria; and
responsive to verifying that the wake-up advertisement and the scan response match the predetermined set of criteria, send the first scan request to the computing device.

12. The system of claim 11, wherein the predetermined set of criteria include at least one of that the wake-up advertisement is part of a correct system, that the wake-up advertisement is sent as part of a correct PAN service, or that the wake-up advertisement corresponds to a same organization as the system.

13. The system of claim 10, wherein connect to the computing device uses a standard connection procedure for the PAN.

14. The system of claim 10, wherein connect to the computing device comprises one or more of the following program instructions, stored on the one or more computer readable storage media, to:
receive a wake-up scan response from the computing device;
send a connection advertisement to the computing device;
receive a second scan request from the computing device;
send a connection scan response to the computing device; and
connect to the computing device.

15. The system of claim 10, wherein the first scan request and the second scan request use a specialized scan request packet.

16. A system for initiating communication in a Personal Area Network (PAN), the system comprising:
a remote device comprising:
communications circuitry, including a wake-up initiation circuitry;
a computing device comprising:
communications circuitry, including an advertisement initiation circuitry;
one or more computer processors;
one or more non-transitory computer readable storage media; and
instructions stored on the one or more non-transitory computer readable storage media for execution by at least one of the one or more computer processors, the stored instructions including instructions to:
send one or more wake-up advertisements to one or more remote devices, wherein the one or more remote devices are scanning for the one or more wake-up advertisements;
receive one or more connection advertisements from the responding remote device; and
responsive to receiving the one or more connection advertisements from the responding remote device, connect to the responding remote device.

17. The system of claim 16, further comprising:
responsive to the remote device receiving the wake-up advertisement, receive a first scan request from a responding remote device;
send a wake-up scan response to the responding remote device;
scan for one or more connection advertisements from the responding remote device;
responsive to receiving the one or more connection advertisements from the responding remote device, send a second scan request to the responding remote device; and
receive a connection scan response from the responding remote device.

18. The system of claim 17, wherein responsive to receiving the one or more connection advertisements from the responding remote device, send the second scan request to the responding remote device further comprises one or more of the following program instructions, stored on the one or more computer readable storage media, to:
send the one or more wake-up advertisements for a holdover period; and
scan for the one or more connection advertisements from one or more additional responding remote devices.

19. The system of claim 17, wherein responsive to receiving the connection scan response from the responding remote device, connect to the responding remote device further comprises one or more of the following program instructions, stored on the one or more computer readable storage media, to:
receive an indication from a user indicating a particular device of the one or more remote devices; and
connect to the particular device of the one or more remote devices.

20. The system of claim 16, wherein the one or more wake-up advertisements use a specialized advertisement packet, and the first scan request and the second scan request use a specialized scan request packet.
